(19) United States
(12) Patent Application Publication
(10) Pub. No.: US 2026/0065135 A1
(43) Pub. Date: Mar. 5, 2026

(54) MULTI-LAYERED CHECK SYSTEMS FOR ARTIFICIAL INTELLIGENCE ("AI") SYSTEMS

(71) Applicant: Bank of America Corporation, Charlotte, NC (US)

(72) Inventor: Manu Kurian, Dallas, TX (US)

(21) Appl. No.: 18/822,725

(22) Filed: Sep. 3, 2024

(51) Int. Cl. G06N 20/00

(52) U.S. Cl. CPC G06N 20/00

(57) ABSTRACT

Computing systems and methods operable to eliminate hallucinations in artificial intelligence (“AI”) systems. The computing systems may include an external database. The external database may contain verified data. The computing systems may include a computing processor operable to deploy the AI system to eliminate hallucinations. The computing systems may include a central server configured to connect the computing processor to the external database. The computing processor may be configured to monitor a query received at the AI system. The computing processor may be configured to extract from the external database, via the central server, verified data relating to the query. The computing processor may be configured to identify layers of checkpoints for the query from the external database. The layers of checkpoints may be based on the verified data extracted. The layers of checkpoints may comprise nodes. The nodes may be configured to modulate outputs from the AI system.

### FIELD OF TECHNOLOGY

Aspects of the disclosure relate to multi-layered check systems for artificial intelligence (“AI”) systems.

### BACKGROUND OF THE DISCLOSURE

AI hallucinations are becoming an increasing problem as entities harness the power of generative AI (“GenAI”) and rely on its capabilities for multiple tasks.

GenAI models may include large language model (“LLM”) chatbots that are trained using deep neural networks. A deep neural network is a model that includes multiple hidden layers between the input and the output. Each of the hidden layers includes artificial neurons that are interconnected. Deep neural networks typically learn from labeled training data in order to predict an output based on inputs in a production environment. These models may be trained to predict strings of words or images that correspond to a request. GenAI models accept natural language requests as input and output generated content.

One problem associated with GenAI models is AI hallucination. A GenAI model may generate false or misleading information and present it as fact. The GenAI model may find patterns or objects that are nonexistent and create outputs that are incorrect.

Conventional systems may attempt to minimize AI hallucinations by limiting the GenAI model, restricting the input data sets, using data templates or regularly reviewing the system. However, none of these approaches can detect or mitigate an AI hallucination output by checking each layer of GenAI processing and output.

It would therefore be desirable to check the output of an LLM at multiple touchpoints to effectively identify and eliminate AI hallucinations.

### SUMMARY OF THE DISCLOSURE

Systems and methods for a computing system operable to eliminate hallucinations in an AI system are provided.

Systems and methods may include a multi-layer check system. The multi-layer check systems and methods may be integrated into an LLM. The multi-layer check systems and methods may be integrated into an LLM while the LLM is generating content.

The multi-layer check systems and methods may include node analysis. Node analysis may ensure that the LLM is not hallucinating. Node analysis may provide a self-correcting mechanism for the LLM for responses that contain hallucinations.

The multi-layer check systems and methods may include a scoring mechanism for LLM responses. The scoring mechanism may include a security score for each LLM response. The scoring mechanism may include a data validation score for each LLM response. The scoring mechanism may include a data accuracy score for each LLM response.

The multi-layer check systems and methods may enable the LLM to self-correct the GenAI before a final response output. Such multi-layer check systems and methods may ensure that each foundational layer of response output is correct before building upon each foundational layer of response output.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2A shows an illustrative flow diagram in accordance with principles of the disclosure;

FIG. 2B shows a continuation of the illustrative flow diagram of FIG. 2A in accordance with principles of the disclosure;

FIG. 3 shows yet another illustrative diagram in accordance with the principles of the disclosure; and

FIG. 4 shows still another illustrative diagram in accordance with the principles of the disclosure.

### DETAILED DESCRIPTION OF THE DISCLOSURE

Systems and methods for a computing system operable to eliminate hallucinations in an AI system are provided.

Systems may include a computing system. The computing system may be operable to eliminate hallucinations in an AI system.

Systems may include an external database. The external database may include verified data. The verified data may be verified by third party sources and authorities.

Systems may include a computing processor. The computing processor may be operable to deploy the AI system to eliminate hallucinations.

Systems may include a central server. The central server may be configured to connect the computing processor to the external database.

The computing processor may be configured to monitor an input received at the AI system. The input may include a query.

The computing processor may be configured to extract from the external database, via the central server, verified data. The verified data may relate to the query.

The computing processor may be configured to identify layers of checkpoints for the query. The layers of checkpoints for the query may be obtained from the external database. The layers of checkpoints may be based on the verified data extracted. The layers of checkpoints may include nodes. The nodes may be configured to modulate outputs from the AI system.

The computing processor may be configured to monitor the outputs from the AI system. The outputs from the AI system may include responses to the query.

The computing processor may be configured to compare the responses to the verified data extracted. The computing processor may be configured to assign a first score to each response. The first score may correspond to a level of similarity between each response and its corresponding verified data extracted. The level of similarity may be, for example, a percentage of correspondence between letters of the response to letters of the verified data.

The computing processor may be configured to, based on the comparing, select, from the AI system, responses from the AI system that are assigned a first score that is greater than a predetermined threshold of similarity.

The computing processor may be configured to link the selected responses to the nodes included in the AI system. The computing processor may be configured to modulate, via the nodes, the AI system to eliminate AI hallucinations by self-correcting the selected responses to conform to the verified data extracted.

The computing processor may be configured to, following the modulation of the AI system to eliminate hallucinations, compare the modulated selected responses to the verified data extracted.

The computing processor may be configured to assign a second score to each modulated selected response. The second score may identify a level of similarity between each modulated selected response and its corresponding verified data extracted.

The computing processor may be configured to, based on the comparing, select, from the AI system, a final response from the AI system that is assigned the second score that is greatest. The computing processor may be configured to output the final response to the query.

The layers of checkpoints may include any number of checkpoints. For example, the layers of checkpoints may include at least three layers of checkpoints. The layers of checkpoints may be based at least in part on personal user data. The layers of checkpoints may be based at least in part on one or more user age ranges. The layers of checkpoints may be based at least in part on one or more user behavior patterns. The layers of checkpoints may be organized in order of least first score to greatest first score of each response.

The layers of checkpoints may be, at least in part, predetermined by the AI system based on a level of complexity of the query. The level of complexity may be being greater than a threshold level of complexity. The level of complexity may be, for example, a score from 0 to 100, where 0 is a minimum level of complexity and 100 is a maximum level of complexity. The threshold level of complexity may be, for example, 70, 75, 80, 85, 95, or 99.

The layers of checkpoints may be, at least in part, based on the verified data extracted from the external database by corresponding to a level of complexity of the verified data extracted. The level of complexity may be greater than a threshold level of complexity.

The final response may be equivalent to at least some of the verified data extracted. An accuracy of the final response may be greater than 90%, 95%, or 99%. The accuracy of the final response may correspond to a percentage of correct letters.

Methods may include providing a computing system operable to eliminate hallucinations in an AI system. Methods may include monitoring, via a computer processor operable to deploy the AI system to eliminate hallucinations, an input received at the AI system. The input may include a query.

Methods may include extracting from an external database, via a central server configured to connect the computer processor to the external database, verified data. The verified data may relate to the query.

Methods may include identifying, via the computer processor, layers of checkpoints for the query from the external database. The layers of checkpoints may be based on the verified data extracted. The layers of checkpoints may include nodes. The nodes may provide self-correction for outputs from the AI system.

Methods may include monitoring, via the computer processor, the outputs from the AI system, the outputs from the AI system comprising responses to the query. Methods may include comparing, via the computer processor, the responses to the verified data extracted.

Methods may include assigning, via the computer processor, a first score to each response. The first score may correspond to a level of similarity between each response and its corresponding verified data extracted.

Methods may include, based on the comparing, selecting, via the computer processor, from the AI system, responses from the AI system that are assigned a first score that is greater than a predetermined threshold of similarity. Methods may include linking, via the computer processor, the selected responses to the nodes included in the AI system.

Methods may include modulating, via the nodes, the AI system to eliminate AI hallucinations by modulating the selected responses to conform to the verified data extracted. Methods may include following the modulation of the AI system to eliminate hallucinations, comparing, via the computer processor, the modulated selected responses to the verified data extracted.

Methods may include assigning, via the computer processor, a second score to each modulated selected response. The second score may identify a level of similarity between each modulated selected response and its corresponding verified data extracted.

Methods may include, based on the comparing, selecting, via the computer processor, from the AI system, a final response from the AI system that is assigned the second score that is greatest. Methods may include outputting, via the computer processor, the final response to the query.

Methods may include providing any number of layers of checkpoints. Methods may include providing, for example, at least three layers of checkpoints.

Methods may include providing layers of checkpoints based at least in part on personal user data. Methods may include providing layers of checkpoints based at least in part on user age range. Methods may include providing layers of checkpoints based at least in part on user behavior pattern. Methods may include providing layers of checkpoints organized in order of least first score to greatest first score of each response.

Methods may include providing at least in part predetermined by the AI system based on a level of complexity of the query. The level of complexity may be greater than a threshold level of complexity.

Methods may include providing layers of checkpoints at least in part based on the verified data extracted from the external database. The layers of checkpoints may correspond to a level of complexity of the verified data extracted. The level of complexity may be greater than a threshold level of complexity.

Methods may include providing a final response equivalent to at least some of the verified data extracted. Methods may include providing a final response with an accuracy of greater than 90%, 95%, or 99%.

Systems and methods described herein are illustrative. Systems and methods in accordance with this disclosure will now be described in connection with the figures, which form a part hereof. The figures show illustrative features of system and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Systems may omit features shown or described in connection with illustrative systems. Embodiments may include features that are neither shown nor described in connection with the illustrative systems. Features of illustrative systems may be combined. For example, an illustrative embodiment may include features shown in connection with another illustrative embodiment.

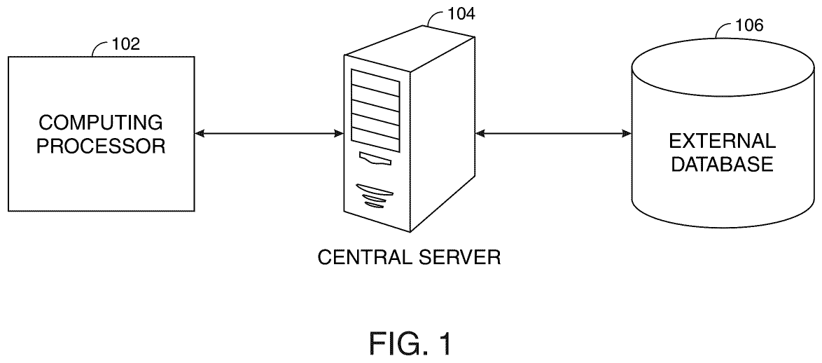

FIG. 1 shows an illustrative diagram. A computing processor is shown at 102. Computing processor 102 may be an AI system.

A central server is shown at 104. The central server 104 may communicate bidirectionally with the computing processor 102.

An external database is shown at 106. The central server 104 may communicate bidirectionally with the external database 106.

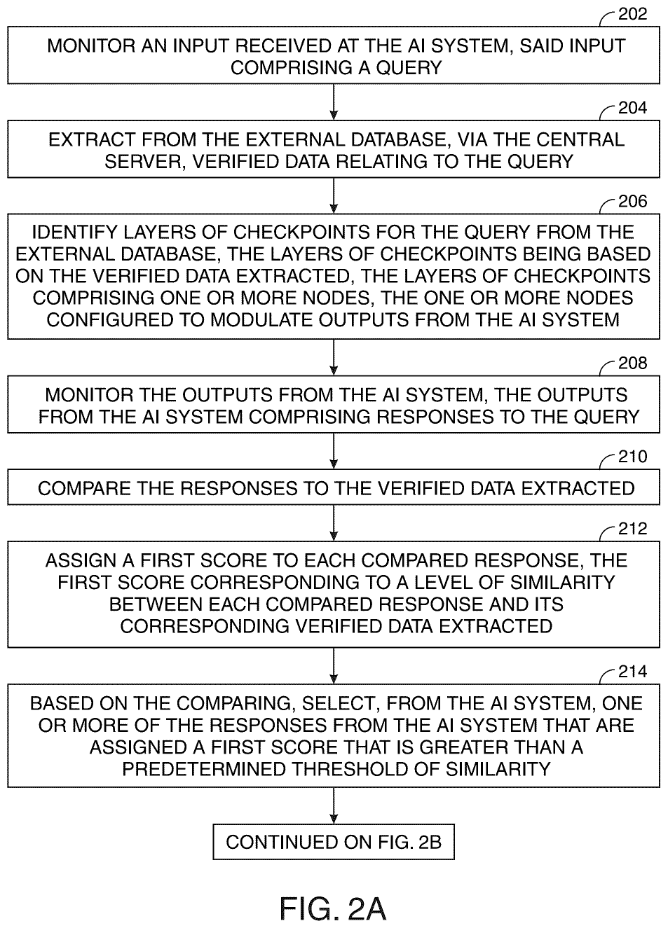

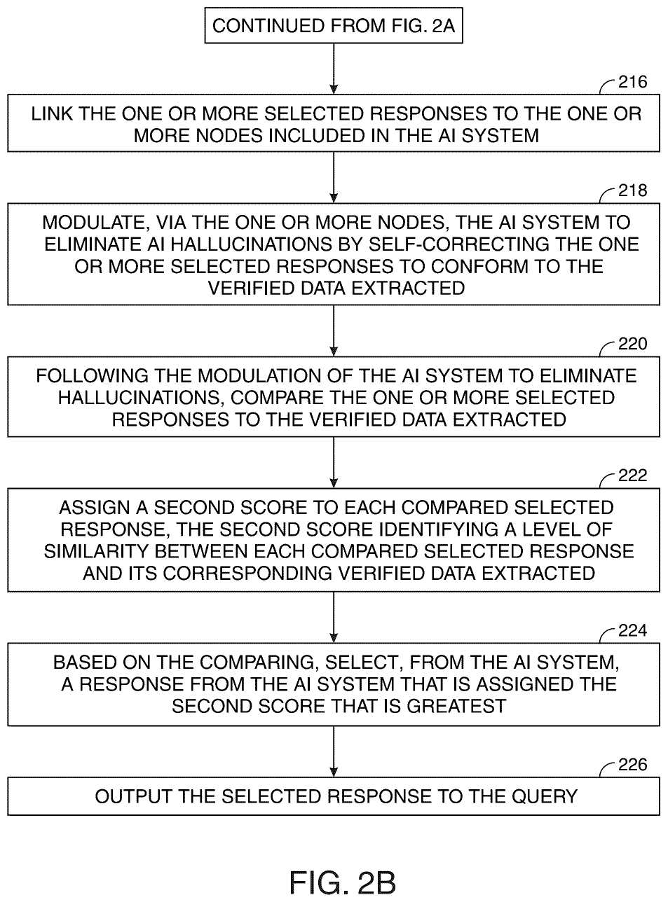

FIG. 2A shows an illustrative flow diagram. The illustrative flow diagram represents an embodied method of eliminating hallucinations in an AI system.

First, at step 202, the method may include monitoring an input received at the AI system. The input may include a query. Next, at step 204, the central server may extract verified data from the external database. The verified data may relate to the query.

Then, at step 206, the method may include identifying layers of checkpoints for the query from the external database. The layers of checkpoints may be based on the verified data extracted. The layers of checkpoints may include one or more nodes. The one or more nodes may be configured to modulate outputs from the AI system.

At step 208, the method may include monitoring the outputs from the AI system. The outputs from the AI system may include responses to the query.

At step 210, the method may include comparing the responses to the verified data extracted. At step 212, the method may include assigning a first score to each compared response. The first score may correspond to a level of similarity between each compared response and its corresponding verified data extracted.

Next, at step 214, the method may include, based on the comparing, selecting, from the AI system, one or more of the responses from the AI system that are assigned a first score that is greater than a predetermined threshold of similarity.

FIG. 2B is a continuation of the illustrative flow diagram of FIG. 2A. FIGS. 2A and 2B represent an embodied method of eliminating hallucinations in an AI system.

At step 216, the method may include linking the one or more selected responses to the one or more nodes included in the AI system.

At step 218, the method may include modulating, via the one or more nodes, the AI system to eliminate AI hallucinations by self-correcting the one or more selected responses to conform to the verified data extracted.

At step 220, the method may include, following the modulation of the AI system to eliminate hallucinations, comparing the one or more selected responses to the verified data extracted.

At step 222, the method may include assigning a second score to each compared selected response. The second score may identify a level of similarity between each compared selected response and its corresponding verified data extracted.

At step 224, the method may include, based on the comparing, selecting, from the AI system, a response from the AI system that is assigned the second score that is greatest.

And at step 226, the method may include outputting the selected response to the query. The selected response may be the final response.

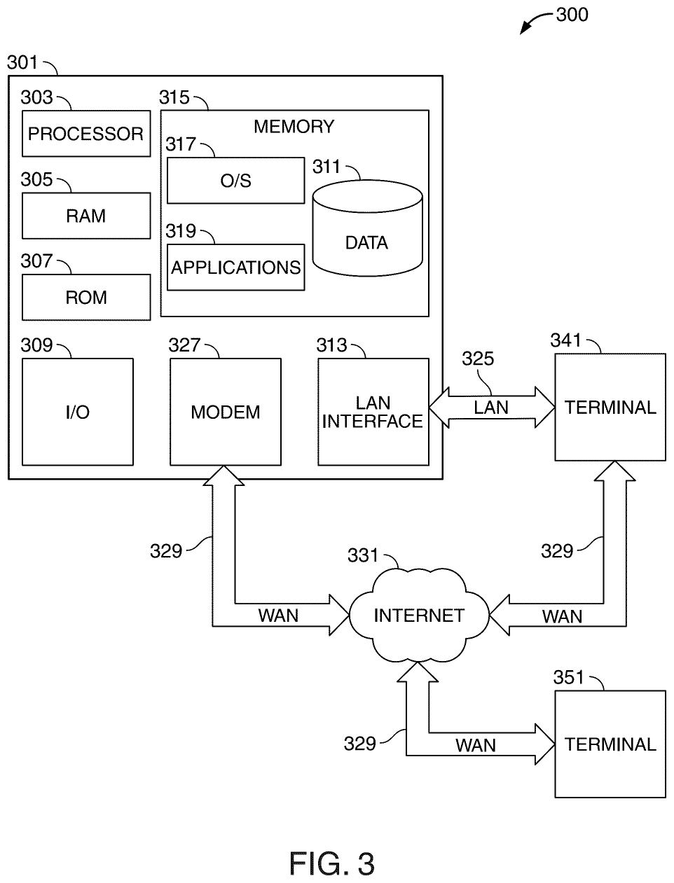

FIG. 3 shows an illustrative block diagram of apparatus 300 that includes computing device 301. Computing device 301 may alternatively be referred to herein as a “control circuit.” Elements of apparatus 300, including computing device 301, may be used to implement various aspects of the apparatus and methods disclosed herein. A “user” of apparatus 300 or a control circuit may include other computer apparatus or servers, such as an authentication server.

Computing device 301 may have a microprocessor 303 for controlling the operation of the device and its associated components, and may include RAM 305, ROM 307, input/output module 309, and a non-transitory memory 315. The microprocessor 303 may also execute all software running on the computing device 301—e.g., the operating apparatus. Other components commonly used for computers, such as EEPROM or Flash memory or any other suitable components, may also be part of the control circuit.

The memory 315 may be comprised of any suitable permanent storage technology—e.g., a hard drive or other non-transitory memory. The ROM 307 and RAM 305 may be included as all or part of memory 315. The memory 315 may store software including the operating system 317 and application(s) 319 along with any other data 311 needed for the operation of the apparatus 300. Memory 315 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The microprocessor 303 may execute the instructions embodied by the software and code to perform various functions.

The term “non-transitory memory,” as used in this disclosure, is a limitation of the medium itself, i.e., it is a tangible medium and not a signal, as opposed to a limitation on data storage types (e.g., RAM vs. ROM). “Non transitory memory” may include both RAM and ROM, as well as other types of memory.

In an embodiment of the computing device 301, the microprocessor 303 may execute the instructions in all or some of the operating system 317, any applications 319 in the memory 315, and any other code embodied in hardware or firmware (not shown).

An input/output (“I/O”) module 309 may include connectivity to a keypad, a touchscreen, a radar transmitter and receiver, or network interface through which higher hierarchal server or a user of apparatus 300 may provide input. The input may include input relating to cursor movement. The input/output module 309 may also include one or more speakers for providing audio output and a video display device, such as an LED screen and/or touchscreen, for providing textual, audio, audiovisual, and/or graphical output (not shown). The input and output may be related to results using and interacting with an ATM.

Apparatus 300 may be connected to other apparatus, computers, servers, and/or the internet via a local area network (LAN) interface 313.

Apparatus 300 may operate in a networked environment supporting connections to one or more remote computers and servers, such as terminals 341 and 351, including, in general, the internet and “cloud”. References to the “cloud” in this disclosure generally refer to the internet. “Cloud-based applications” generally refer to applications located on a server remote from a user, wherein some or all of the application data, logic, and instructions are located on the internet and are not located on a user's local device. Cloud-based applications may be accessed via any type of internet connection (e.g., cellular or wi-fi).

Terminals 341 and 351 may be personal computers or servers that include many or all of the elements described above relative to apparatus 300. The network connections depicted in FIG. 3 include a local area network (LAN) 325 and a wide area network (WAN) 329 but may also include other networks, such as a cellular network. Computing device 301 may include a network controller interface (not shown), which may include a modem 327 and LAN interface or adapter 313, as well as other components and adapters (not shown). When used in a LAN networking environment, computing device 301 is connected to LAN 325 through a LAN interface or adapter 313. When used in a WAN networking environment, computing device 301 may include a modem 327 or other means for establishing communications over WAN 329, such as Internet 331. The modem 327 and/or LAN interface 313 may connect to a network via an antenna (not shown). The antenna may be configured to operate over Bluetooth, Wi-Fi, cellular networks (including 5G), or other suitable frequencies.

It will be appreciated that the network connections shown are illustrative and other means of establishing a communications link between computers may be used. The existence of various well-known protocols such as TCP/IP, Ethernet, FTP, HTTP and the like is presumed, and the apparatus can be operated in a client-server configuration to permit a user to retrieve web pages from a web-based server. The web-based server may transmit data to any other suitable computer apparatus. The web-based server may also send computer-readable instructions, together with the data, to any suitable computer apparatus. The computer-readable instructions may be to store the data in cache memory, the hard drive, secondary memory, or any other suitable memory.

Application program(s) 319 (which may be alternatively referred to herein as “plugins,” “applications,” or “apps”) may include computer executable instructions for invoking user functionality related to performing various tasks such as interacting with an ATM. In an embodiment, application program(s) 319 may be cloud-based applications.

The various tasks may be related to authenticating a user and processing one or more ATM transactions.

Computing device 301 may also include various other components, such as a battery (not shown), power supply (not shown), radar components (not shown), screen (not shown), speaker (not shown), network controller interface (not shown), and/or antennas (not shown).

Terminal 351 and/or terminal 341 may be portable devices such as a laptop, cell phone, Blackberry (TM), tablet, smartphone, or any other suitable device for receiving, storing, transmitting and/or displaying relevant information. Terminals 351 and/or terminal 341 may be other devices such as remote servers, including authentication and transaction servers. Terminals 351 and/or 341 may be computers where a user is interacting with an application.

Any information described above in connection with data 311, and any other suitable information, may be stored in memory 315. One or more of applications 319 may include one or more algorithms that may be used to implement features of the disclosure, and/or any other suitable tasks.

The invention may be operational with numerous other general purpose or special purpose computing apparatus environments or configurations. Examples of well-known computing systems, environments, and/or configurations that may be suitable for use with the invention include, but are not limited to, personal computers, server computers, handheld or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like. Secure systems and servers may be preferable.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications or remote authentication protocols. In a distributed computing environment, program modules may be located in both local and remote computer storage media including memory storage devices.

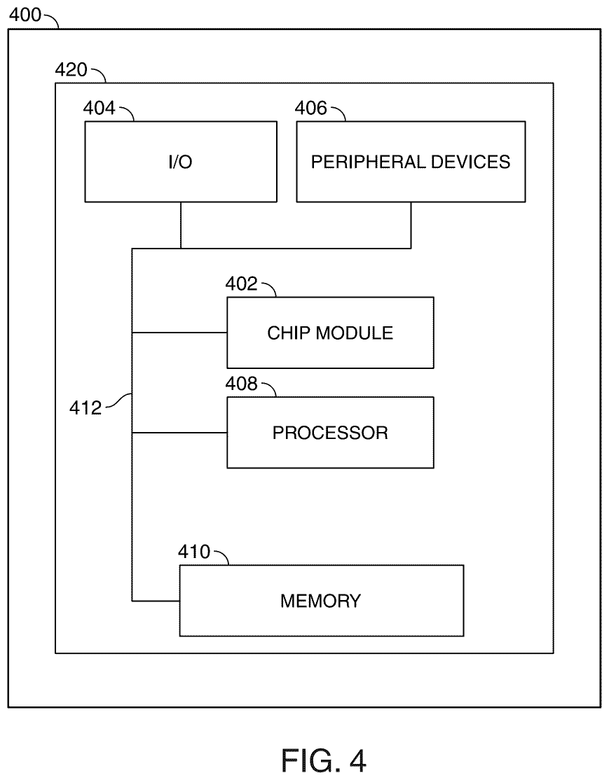

FIG. 4 shows illustrative apparatus 400 that may be configured in accordance with the principles of the disclosure. Apparatus 400 may be a server or computer various peripheral devices 406. Apparatus 400 may include one or more features of the apparatus shown in FIGS. 1-3. Apparatus 400 may include circuit board 420 and chip module 402, which may include one or more integrated circuits, and which may include logic configured to perform any other suitable logical operations.

Apparatus 400 and/or circuit board 420 may include one or more of the following components: I/O circuitry 404, which may include a transmitter device and a receiver device and may interface with fiber optic cable, coaxial cable, telephone lines, wireless devices, PHY layer hardware, a keypad/display control device, an LED screen, a touchscreen, a radar transmitter and receiver, or any other suitable media or devices; peripheral devices 406, which may include batteries and chargers, counter timers, real-time timers, power-on reset generators or any other suitable peripheral devices; logical processing device 408, which may compute data structural information and structural parameters of the data; and machine-readable memory 410.

Machine-readable memory 410 may be configured to store in machine-readable data structures: machine executable instructions (which may be alternatively referred to herein as “computer instructions” or “computer code”), applications, signals, encryption algorithm(s), recorded data, and/or any other suitable information or data structures.

Components 402, 404, 406, 408 and 410 may be coupled together by a system bus or other interconnections 412 and may be present on one or more circuit boards such as 420. In some embodiments, the components may be integrated into a single chip. The chip may be silicon-based.

Thus, multi-layered check systems and methods for eliminating AI hallucinations are provided. Persons skilled in the art will appreciate that the present invention can be practiced by other than the described embodiments, which are presented for purposes of illustration rather than of limitation. The present invention is limited only by the claims that follow.

What is claimed is:

1. A computing system operable to eliminate hallucinations in an artificial intelligence (“AI”) system, the computing system comprising:
an external database, the external database comprising verified data;
a computing processor, the computing processor operable to deploy the AI system to eliminate hallucinations; and
a central server, the central server configured to connect the computing processor to the external database;
wherein the computing processor is configured to:
monitor an input received at the AI system, said input comprising a query;
extract from the external database, via the central server, verified data relating to the query;
identify layers of checkpoints for the query from the external database, the layers of checkpoints being based on the verified data extracted, the layers of checkpoints comprising nodes, the nodes configured to modulate outputs from the AI system;
monitor the outputs from the AI system, the outputs from the AI system comprising responses to the query;
compare the responses to the verified data extracted;
assign a first score to each response, the first score corresponding to a level of similarity between each response and its corresponding verified data extracted;
based on the comparing, select, from the AI system, selected responses from the AI system that are assigned a first score that is greater than a predetermined threshold of similarity;
link the selected responses to the nodes included in the AI system;
modulate, via the nodes, the AI system to eliminate AI hallucinations by self-correcting the selected responses to conform to the verified data extracted;
following the modulation of the AI system to eliminate hallucinations, compare the modulated selected responses to the verified data extracted;
assign a second score to each modulated selected response, the second score identifying a level of similarity between each modulated selected response and its corresponding verified data extracted;
based on the comparing, select, from the AI system, a final response from the AI system that is assigned the second score that is greatest; and
output the final response to the query.

2. The system of claim 1 wherein the layers of checkpoints comprise at least three layers of checkpoints.

3. The system of claim 1 wherein the layers of checkpoints are based at least in part on personal user data.

4. The system of claim 1 wherein the layers of checkpoints are based at least in part on a user age range.

5. The system of claim 1 wherein the layers of checkpoints are based at least in part on a user behavior pattern.

6. The system of claim 1 wherein the layers of checkpoints are organized in order of least first score to greatest first score of each response.

7. The system of claim 1 wherein the layers of checkpoints are at least in part predetermined by the AI system based on a level of complexity of the query, the level of complexity being greater than a threshold level of complexity.

8. The system of claim 1 wherein the layers of checkpoints are based on the verified data extracted from the external database by corresponding to a level of complexity of the verified data extracted, the level of complexity being greater than a threshold level of complexity.

9. The system of claim 1 wherein the final response is equivalent to at least some of the verified data extracted.

10. The system of claim 1 wherein an accuracy of the final response is greater than 99%.

11. A method of eliminating hallucinations in an artificial intelligence (“AI”) system, the method comprising:
monitoring, via a computer processor operable to deploy the AI system to eliminate hallucinations, an input received at the AI system, said input comprising a query;
extracting from an external database, via a central server configured to connect the computer processor to the external database, verified data relating to the query;
identifying, via the computer processor, layers of checkpoints for the query from the external database, the layers of checkpoints being based on the verified data extracted, the layers of checkpoints comprising nodes, the nodes providing self-correction for outputs from the AI system;
monitoring, via the computer processor, the outputs from the AI system, the outputs from the AI system comprising responses to the query;
comparing, via the computer processor, the responses to the verified data extracted;
assigning, via the computer processor, a first score to each response, the first score corresponding to a level of similarity between each response and its corresponding verified data extracted;
based on the comparing, selecting, via the computer processor, from the AI system, selected responses from the AI system that are assigned a first score that is greater than a predetermined threshold of similarity;
linking, via the computer processor, the selected responses to the nodes included in the AI system;
modulating, via the nodes, the AI system to eliminate AI hallucinations by modulating the selected responses to conform to the verified data extracted;
following the modulation of the AI system to eliminate hallucinations, comparing, via the computer processor, the modulated selected responses to the verified data extracted;
assigning, via the computer processor, a second score to each modulated selected response, the second score identifying a level of similarity between each modulated selected response and its corresponding verified data extracted;
based on the comparing, selecting, via the computer processor, from the AI system, a final response from the AI system that is assigned the second score that is greatest; and
outputting, via the computer processor, the final response to the query.

12. The method of claim 11 wherein the layers of checkpoints comprise at least three layers of checkpoints.

13. The method of claim 11 wherein the layers of checkpoints are based at least in part on personal user data.

14. The method of claim 11 wherein the layers of checkpoints are based at least in part on a user age range.

15. The method of claim 11 wherein the layers of checkpoints are based at least in part on a user behavior pattern.

16. The method of claim 11 wherein the layers of checkpoints are organized in order of least first score to greatest first score of each response.

17. The method of claim 11 wherein the layers of checkpoints are at least in part predetermined by the AI system based on a level of complexity of the query, the level of complexity being greater than a threshold level of complexity.

18. The method of claim 11 wherein the layers of checkpoints are based on the verified data extracted from the external database by corresponding to a level of complexity of the verified data extracted, the level of complexity being greater than a threshold level of complexity.

19. The method of claim 11 wherein the final response is equivalent to at least some of the verified data extracted.

20. The method of claim 11 wherein an accuracy of the final response is greater than 99%.
